(19) United States
(12) Patent Application Publication
(10) Pub. No.: US 2004/0259562 A1
(43) Pub. Date: Dec. 23, 2004

(54) Method and packet data service node for correlating a service reference identifier with a requested quality of service

(76) Inventor: Lila Madour, Kirkland (CA)

Correspondence Address: Ericsson Canada Inc., Patent Department (LMC/M/P), 8400 Decarie Blvd., Town Mount Royal, QC, H4P 2N2, CA

(21) Appl. No.: 10/819,927

(22) Filed: Apr. 8, 2004

Related U.S. Application Data
(60) Provisional application No. 60/461,830, filed on Apr. 11, 2003.

(51) Int. Cl. H04Q 7/20

(52) U.S. Cl. 455/452.2

(57) ABSTRACT

A method and a Packet Data Service Node (PDSN) for informing a mobile station of a correlation between an auxiliary service instance and a resource request. A resource request is received at the Packet Data Service Node from the mobile station, the resource request including a specified quality of service requirement. The PDSN generates and sends a message to a serving Radio Access Network requesting establishment of an auxiliary service instance with the specified quality of service for the mobile station. Afterwards, the PDSN receives a confirmation message from the Radio Access Network confirming establishment of the auxiliary service instance between the Radio Access Network and the mobile station. The confirmation message includes a reference identifier corresponding to the auxiliary service instance. The PDSN informs the mobile station of the reference identifier and its correlation to the resource request.

### PRIORITY STATEMENT UNDER 35 U.S.C. S.119 (e) & 37 C.F.R. S.1.78

This non-provisional patent application claims priority based upon the prior U.S. provisional patent application entitled “Non-transparent RSVP in a cdma2000 packet data network”, application No. 60/461,830, filed Apr. 11, 2003, in the name of Lila MADOUR.

### BACKGROUND OF THE INVENTION

1. Field of the Invention

The present invention relates to a method and a Packet Data Service Node and Mobile Station for correlating a service reference identifier with a requested quality of service.

2. Description of the Related Art

The first generation of mobile networks were designed for carrying voice conversations only. With the advent of services such as Internet, mobile telecommunication subscribers' expectancies have greatly increased. Since then, the mobile networks have evolved to allow packet data transfer, Voice over Internet Protocol, and more recently to provide simultaneous multiple voice and data services. To allow such array of services, new radio accesses and network protocols have been developed.

The most recent mobile network protocols and radio accesses have been inspired by previous generations of mobile networks and by computer network protocols. The results are sometimes surprising to both telecommunications engineer and computer engineers, but such a merging of technologies does not happen without its share of problems. For example, previous mobile networks. were focusing on allowing as many mobile users as possible, while providing the best voice quality and a high reliability. At the same time, computer networks were focusing on high-speed data transfer, low-cost routers and strong recovery algorithms for lost packets. The gap between the mobile telecommunications and computer networks was quite important. But mobile networks system architects have had to overcome many technological problems to meet subscribers' expectations: high levels of voice quality and reliability, while being able to surf the Internet from their mobile phone, or accessing remote applications and performing data packet communications.

Numerous examples of such merging of technologies can be found in a protocol that was developed for more recent generations of mobile networks: Code Division Multiple Access 2000 (cdma2000) packet data network. That mobile network protocol has reused Point-to-Point Protocol (PPP) between a Mobile Station (MS) and a Packet Data Service Node (PDSN) over a Radio Access Network (RAN). Cdma200 opens a PPP connection between the MS and the PDSN, and allows having multiple service instances simultaneously open for allowing multiple simultaneous services/applications to one MS. The first service instance that was established is called the main service instance, while the other service instances are called auxiliary service instances. The PPP traffic, and any other such traffic are transported on the main service instance.

However, different services and applications translate into different quality of service (QoS). One problem arises in cdma2000 when the MS requires an additional service instance with a different QoS than already obtained during negotiations for the main service instance over the PPP connection. To overcome this problem, standard committees have turned to another protocol known to computer engineers: Resource Reservation Protocol (RSVP). RSVP is described in a document at the Internet Engineering Task Force (IETF), titled Request for Comments (RFC) 2205.

More particularly, an RSVP Reservation message has been introduced to request, by the MS of an application thereof, a new auxiliary service instance with a different QoS to the PDSN. However, RSVP defines messages and context in which such messages should be sent, and one important aspect is that RSVP traffic should be transported over the same path that the requesting application/entity will take. However, due to the cdma2000 architecture, it is not possible to use such path, and the RSVP Reservation message is sent over the main service instance, to conform to PPP requirements that all IP control traffic (e.g., Mobile IP, RSVP) between the MS and the PDSN is sent over the main service instance.

This derogation from RSVP requirements creates some problems. Since the RSVP Reservation message is not sent over the same path than the application/MS will be using, there is no way for the application/MS to know that a newly established auxiliary service instance corresponds to the RSVP Reservation message sent.

Accordingly, it should be readily appreciated that in order to overcome the deficiencies and shortcomings of the existing solutions, it would be advantageous to have a method and a Packet Data Service Node for effectively correlating an auxiliary service instance to an RSVP Reservation message with specified QoS and thus provide that mapping to the MS. The present invention provides such a method and Packet Data Service Node.

### SUMMARY OF THE INVENTION

In one aspect, the present invention is a method for informing a Mobile Station (MS) of a correlation between a newly opened auxiliary service instance and a previously sent resource request. A Packet Data Service Node (PDSN) receives a resource request from the MS with a specified quality of service requirement. The PDSN generates and sends a message to a Radio Access Network (RAN) requesting establishment of an auxiliary service instance with the MS, and precising that the auxiliary service instance requires the specified quality of service. Afterwards, the PDSN receives a confirmation message from the RAN, confirming establishment of the auxiliary service and providing a reference identifier corresponding to the auxiliary service instance. The method is characterized in that the PDSN informs the mobile station of the reference identifier and its correlation to the resource request.

In another aspect, the present invention is a Packet Data Service Node (PDSN) for informing a Mobile Station (MS) of a correlation between an auxiliary service instance and a resource request. The PDSN receives a resource request from the MS with a specified quality of service requirement. The PDSN then generates and sends a message to a Radio Access Network (RAN) requesting establishment of an auxiliary service instance with the MS, with the specified quality of service. The PDSN receives a confirmation message from the RAN confirming establishment of the auxiliary service instance between the RAN and the MS. The confirmation message includes a reference identifier corresponding to the auxiliary service instance. The PDSN is characterized in that it sends an information message comprising the reference identifier and a correlation to the resource request to the MS.

### BRIEF DESCRIPTION OF THE DRAWING

For a more detailed understanding of the invention, for further objects and advantages thereof, reference can now be made to the following description, taken in conjunction with the accompanying drawing, in which:

FIG. 1 is a signal flow diagram for correlating a service instance identifier with a quality of service request.

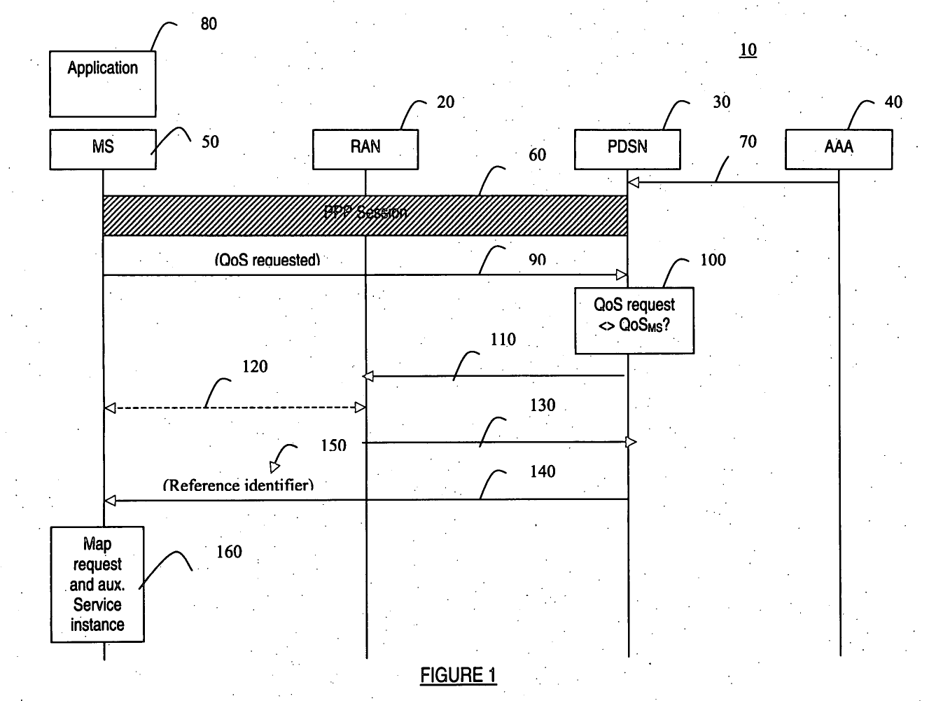

### DETAILED DESCRIPTION OF THE PREFERRED EMBODIMENTS

The innovative teachings of the present invention will be described with particular reference to various exemplary embodiments. However, it should be understood that this class of embodiments provides only a few examples of the many advantageous uses of the innovative teachings of the invention. In general, statements made in the specification of the present application do not necessarily limit any of the various claimed aspects of the present invention. Moreover, some statements may apply to some inventive features but not to others.

The present invention relates to packet data networks, and more particularly to packet data networks supporting communications with mobile stations. In the foregoing description, the expression mobile station is used, and includes, without being limited thereto, the following: cellular phones, mobile Personal Digital Assistants, wireless computers, computer connected to cellular phones, applications communicating through a cellular phone, etc. The packet data network 10 may use. and/or support standards such as: Mobile Internet Protocol, 3^{rd} Generation Partnership Project 2 (3GPP2), [provide other standards, if possible], but is not limited to such standards and could be applicable to any other such type of standards.

The packet data network 10 is composed, amongst other things, of a Radio Access Network (RAN) 20, a Packet Data Service Node 30 and an Authentication, Authorization and Accounting (AAA) node 40. The RAN 20 usually includes base stations, one or many base station controllers and sometimes one or many Mobile Switching Centers (MSC), which have been omitted for clarity purposes. The RAN 20 communicates with one or many mobile stations (MS) 50 over a radio air. interface (not shown), which may use protocols such as Code Division Multiple Access (CDMA), or CDMA2000, or any other radio protocols supporting packet data communications. The PDSN 30 acts as doorway between the RAN 20 and other networks such as Internet or other packet data networks. The PDSN 30 also takes over the role of Agent, either as Home Agent or Foreign Agent, for mobile stations it is servicing. The PDSN 30 is also responsible for. communicating with the AAA 40, for authenticating and maintaining accounting information for the MS 50 it services. For these purposes, the AAA 40 stores and maintains information on approved services for the MS 50 subscribed to its corresponding packet data network, and also actively handles accounting issues for the MS 50.

3GPP2 has established an infrastructure for the exchange of messages and communications between nodes of packet data networks. It also describes necessary steps and information needed to provide specific services to mobile stations. One such service is the support of end-to-end quality of service. This service allows a MS to require and obtain a different level of quality of service, which is sometimes needed for specific applications running over the MS, and exchanging information with another MS, or a remote application, outside of the packet data network.

Before proceeding with a packet data communication, a Point-to-Point Protocol (PPP) session 60 is established between the MS 50 and the PDSN 30. During the establishment of the PPP session 60, the PDSN 30 obtains from the AAA 40 (step 70) information about the MS 50, and proceeds with authenticating the MS 50. The completion of the PPP session also includes the creation of a service instance, hereinafter called main packet service instance. In 3GPP2, service instances are negotiated through the use of service options. Service options are either circuit-oriented or packet-oriented. 3GPP2 defines the following service instance types: circuit service instance, packet service instance, main packet service instance, and auxiliary packet service instance.

Circuit service instance refers to a service instance that is switched through a Mobile Switching Center (MSC). The PDSN 30 is not involved in these service instances. Packet service instance refers to a service instance that is routed through the PDSN 30. For this type of service instance, the MSC is involved:in initiating such a service instance, but never in routing user data. Main packet service instance refers to the service instance that is first negotiated when establishing the packet service. It also implicates that the establishment of the PPP session 60 takes place over this service instance. Typically, the quality of service characteristics of the main packet service instance takes on a default value, based on information maintained in the AAA 40 for the MS 50, and on operator-defined policies. Auxiliary packet service instances refer to additional service instances that are initiated on an as needed basis. The quality of service characteristics of the auxiliary packet service instances are based on the needs of the MS 50, or on the needs of an application 80 using the auxiliary packet service instance. Several auxiliary packet service instances may be obtained, in addition to the main service instance, for a single MS.

When the MS 50, or application 80, needs a specific quality of service, it must provide a traffic class to the packet data network 10. 3GPP2 has defined four different traffic classes: background, interactive, streaming and conversational. The background traffic class is used for non-interactive and non real-time packet data communications, such as for example File Transfer Protocol (FTP) or other types of bulk downloads. The interactive traffic class is recommended for interactive, but non real-time packet data communications, such as web browsing, instant messaging, telnet, news, etc. The streaming traffic class is generally used for non-interactive, but real-time applications. Examples of such applications include streaming audio. and video. As to the conversational traffic class, it is designed to support interactive and real-time applications, such as voice and video conferencing.

After the establishment of the PPP session 60, and its corresponding main packet service instance, the MS 50, or the application 80 running there over requires a service instance with a different type of quality of service. To initiate the establishment of an additional service instance to support the different quality of service, the MS 50 sends a resource request message 90 to the PDSN 30 over the RAN 20. The resource request message 90 may consist, for example, of a service instance establishment message, also known as A11 RRQ [Please expand], or a Resource Reservation Protocol (RSVP) Reservation message. The resource request message 90 includes a quality of service (QoS) requirement, which could consist of one of the previously described traffic classes for example.

Upon receipt of the resource request message 90 at the PDSN 30, the PDSN 30 may optionally perform a verification 100 to determine whether the quality of service required by the MS 50 is authorized for the MS 50. If the requested quality of service is allowed for the MS 50, the PDSN 30 generates and sends a Session Update message 110 to the RAN 20 over a link layer. The Session Update message 110 includes the requested quality of service and an identifier for the MS 50. The RAN 20 receives the Session Update message 110, and creates an auxiliary packet service instance 120 with the requested quality of service with the MS 50 over the PPP session 60. The RAN 20 sends a confirmation message 130 to the PDSN 30, for confirming the establishment of the auxiliary packet data service for the MS 50 over the link layer. The confirmation message 130 may consist of a RAN to PDSN (R-P) connection message. The confirmation message 130 includes a service reference identifier corresponding to the auxiliary packet service instance established for the MS 50.

Because by definition RSVP is used only for a current connection, and in the present 3GPP2 implementation RSVP is used on the main packet service instance for requesting the establishment of the auxiliary packet service instance, the present invention is needed to inform the MS 50 that the newly created auxiliary packet service instance 120 responds to the resource request message 90. For doing so, the PDSN 30 informs the MS 50 of the correlation between the established auxiliary packet service instance 120 with the resource request message 90. The PDSN 30 sends a confirmation message 140, including the service reference identifier 150, to the MS 50.—The confirmation message 140 may consist of an RSVP Reservation Confirmation message, or of an IP confirmation message. In the case of the IP confirmation message, the latter further includes an indication of the requested quality of service requirement. It is to be noted that the confirmation message 140 is of the same type as the resource request message sent by the MS 50 (i.e. RSVP if RSVP Reservation message sent, or IP if IP request sent). The confirmation message 140 is sent over an IP layer, through the main service instance of the PPP session 60.

Upon receipt of the confirmation message 140 by the MS 50, the latter proceeds with the mapping 160 of the received service reference identifier 150 with the resource request message 90, and thus determines that the established auxiliary packet service instance 120 corresponds to the requested quality of service. Without such a confirmation message 140 from the PDSN 30, the MS 50 cannot correlate the auxiliary packet service instance 120 with the requested quality of service message 90 and will not be able to map the corresponding application traffic to the service instance.

It should be noted that it is possible for the MS 50 to have over the PPP session 60 one main service instance, and many auxiliary service instances concurrently open. It is also possible that the MS 50 sends a plurality of resource requirement messages 90 needed by various applications 80 simultaneously open and requiring different qualities of services. The present invention also applies to such situations.

Note that the above uses the Service Reference ID as a parameter to correlate the resource request with the established service instance or connection. The Service Reference ID is used with cdma2000 technologies such as 1×. With High Rate Packet Data access technology, other identifiers may be used, but the concept remains equivalent.

Based upon the foregoing, it should now be apparent to those of ordinary skills in the art that the present invention provides an advantageous solution, which allows the PDSN to inform the MS of the correlation between a resource request and the establishment of the auxiliary packet service instance. Although the PDSN and method of the present invention have been described in particular reference to 3GPP2, it should be realized upon reference hereto that the innovative teachings contained herein are not necessarily limited thereto and may be implemented advantageously with any applicable standard.

It will be understood that the invention is not limited to the embodiments disclosed, but is capable of numerous rearrangements, modifications and substitutions without departing from the spirit of the invention as set forth and defined by the following claims.

What is claimed is:

1. A method for informing a mobile station of a correlation between an auxiliary service instance or QoS connection and a resource request, the method comprising steps of:
receiving at the Packet Data Service Node a resource request from the mobile station with a specified quality of service requirement,
generating and sending from the Packet Data Service Node a message to a serving Radio Access Network requesting establishment of an auxiliary service instance with the specified quality of service with the mobile station;
receiving at the Packet Data Service Node a confirmation message from the Radio Access Network confirming establishment of the auxiliary service instance between the Radio Access Network and the mobile station, the confirmation message including a reference identifier corresponding to the auxiliary service instance, the method being characterized in that:
the Packet Data Service Node informs the mobile station of the reference identifier and its correlation to the resource request.

2. The method of claim 1, being further characterized in that:
a PPP connection is established between the Packet Data Service Node and the mobile station;
the resource request received at the Packet Data Service Node is a Resource Reservation Protocol (RSVP) Reservation message sent over the PPP connection; and
the Packet Data Service Node informs the mobile station of the reference identifier and its correspondence to the resource request by sending an RSVP Reservation Confirmation message including the reference identifier over the PPP connection.

3. The method of claim 1, being further characterized in that, prior to the step of generating and sending the message requesting establishment of the auxiliary service, it further includes a step of verifying at the Packet Data Service Node that the requested level of quality of service is approved for the mobile station.

4. The method of claim 2, being further characterized in that the RSVP Reservation message is received over a main service instance of the PPP connection.

5. The method of claim 2, being further characterized in that the specified quality of service requirement received at the Packet Data Service Node is different than a current quality of service for a main service instance of the PPP connection.

6. The method of claim 1, being further characterized in that the Packet Data Service Node informs the mobile station of the reference identifier and its correspondence to the resource request by sending an IP Confirmation message including the reference identifier and an indication of the requested quality of service requirement.

7. A Packet Data Service Node (PDSN) for informing a mobile station of a correlation between an auxiliary service instance and a resource request, the PDSN being adapted to:
receive a resource request from the mobile station with a specified quality of service requirement,
generate and sending a message to a Radio Access Network requesting establishment of an auxiliary service instance with the specified quality of service for the mobile station;
receive a confirmation message from the Radio Access Network confirming establishment of the auxiliary service instance between the Radio Access Network and the mobile station, the, confirmation message including a reference identifier corresponding to the auxiliary service instance,
the PDSN being characterized by:
being adapted to send an information message to the mobile station, the information message comprising a reference identifier and a correspondence to the resource request.

8. The PDSN of claim 7, being further characterized in that:
a PPP connection is established between the Packet Data Service Node and the mobile station;
the resource request is a Resource Reservation Protocol (RSVP) Reservation message sent over the PPP connection;
the information message is an RSVP Reservation Confirmation message sent over the PPP connection; and
the reference identifier is a service reference identifier.

9. The PDSN of claim 7, being further characterized by verifying that the requested level of quality of service is approved for the mobile station, prior to sending the message for the Radio Access Network.

10. The PDSN of claim 8, being further characterized in that the RSVP Reservation message is received over a main service instance of the PPP connection.

11. The PDSN of claim 8, being further characterized in that the specified quality of service requirement received is different than a current quality of service for a main service instance of the PPP connection.

12. The PDSN of claim 7, being further characterized in that the information message is an IP Confirmation message including the reference identifier and an indication of the requested quality of service requirement.
